(19) United States
(12) Patent Application Publication
(10) Pub. No.: US 2005/0240470 A1
(43) Pub. Date: Oct. 27, 2005

(54) Limited constituency advertising calendar

(76) Inventor: Thomas W. Bury, College Park, MD (US)

Correspondence Address: William S. Ramsey, 5253 Even Star Place, Columbia, MD, 21044, US

(21) Appl. No.: 10/638,765

(22) Filed: Aug. 11, 2003

(51) Int. Cl. G06F 17/60; B42D 5/04

(52) U.S. Cl. 705/14; 283/2

(57) ABSTRACT

This invention is a method of producing a calendar containing advertisements by suppliers and distributors, both of which are members of a limited constituency. The calendars are for the use by customers of the distributors, who typically are retailers. The advertisements of the suppliers feature product information and promotional offerings of the suppliers who are identified only by identification symbols such as numbers. The advertisements of the distributors, who distribute items manufactured by the suppliers, feature accessible information allowing contact with the distributors and may include promotional offers. The distributors provide their customers, typically retailers, with the calendars and take orders for items listed by the advertisers and others

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention

This invention relates to the production and distribution of calendars.

2. Description of Related Art Including Information Disclosed Under 37 CFR 1.97 and 37 CFR 1.98.

This invention is a method of producing a calendar containing advertisements by suppliers and distributors, both of which are members of a limited constituency. The calendars are for the use by customers of the distributors, who typically are retailers. The advertisements of the suppliers feature product information and promotional offerings of the suppliers who are identified only by identification symbols such as numbers. The advertisements of the distributors, who distribute items manufactured by the suppliers, feature accessible information allowing contact with the distributors and may include promotional offers. The distributors provide their customers, typically retailers, with the calendars and take orders for items listed by the advertisers and others.

U.S. Pat. No. 5,106,122 discloses a combination calendar and catalogue in which information on the products depicted on the calendar is provided. Tabs at the bottom or edge of the calendar are attached to product information sheets and provide convenient access to specific products and ordering information.

U.S. Pat. No. 5,316,342 discloses a calendar with space for a child to add art on each of the 12 months and means for attaching the calendar to a refrigerator. The space for original art work covers at least half of the area of each page.

U.S. Pat. No. 6,186,553 discloses a theme calendar which the customer may customize with personal information and interests. The calendar may start and stop on individualize chosen dates and may include customized entries for each day.

U.S. Pat. No. 6,536,965 discloses a calendar producing system in which a user selects from a variety of pictures for the calendar, prints the calendar, and provides special indications for certain days as selected by the user. The calendar can be ordered and produced throughout the year.

Published Patent Application U.S. 2001/0032133 discloses a system for message delivery in which message companies provide ads and content companies provide content, the message is sent through the internet and received by the individual members of the audience.

Published Patent Applications U.S. 2001/0051901 discloses a method for linking retailer and database and consumer. The consumer can determine the product availability, view discounts and specials, and plan its visit to the retail store.

Published Patent Applications U.S. 2002/0052775 discloses a system for developing and implementing a multi-activity marketing plan.

Published Patent Applications U.S. 2002/0114220 discloses a calendar which is provided by a business which uses regular appointments, such as beauty parlor or dentist. The calendar includes ads, the appointment dates, information on the business, and would be designed to cover the period of time between appointments.

The prior art does not disclose the advantages of the present invention, which provides a method of producing and manufacturing a calendar for distribution by a limited constituency. The advertisers featuring product information and promotional offerings and the distributors, who distribute items manufactured by the advertisers, both are members of the limited constituency. The distributors provide retailers with the calendars and take orders for items listed by the advertisers and others.

### BRIEF SUMMARY OF THE INVENTION

The process of producing calendars in which both the suppliers who advertise in the calendars and the distributors of the calendars to customers are both members of a limited constituency. The customers are not members of the limited constituency. The process comprises the following steps. The calendar producer solicits advertisements and suppliers' promotional offers from suppliers who are members of a limited constituency. In addition, an advertisement is solicited from a distributor who is a member of the limited constituency. The order of the first two steps is not important. The next step is combining the advertisements and suppliers' promotional offers into printed calendars. The calendars are then printed. The calendars comprise accessible information about the distributor and only identifying symbols about the suppliers. The printed calendars then are sold to the distributor who is a member of the limited constituency. The calendars are then distributed by the distributor to retailers who are termed “customers” in this patent application, who use the advertisements in selecting the products advertised by the suppliers. The customers then provide their patrons (termed “users”) with the promotional specialty items which are customized with the customer's logo, name, address, telephone number, website, e-mail address, etc.

The objective of this invention is to provide a method for manufacturing calendars with advertising of supplier's products and distributor's services.

Another objective is to provide calendars with both advertisements from suppliers and a distributor and with promotional offers from suppliers and or the distributor.

Another objective is to provide a method of producing calendars containing advertising of suppliers' products without providing information which allows direct contact with the suppliers while bypassing the distributor who provided the calendar.

Another objective is to provide a method of producing calendars with advertising themes based on the changing seasons and holidays.

Another objective is to provide a method of producing calendars inexpensively.

### BRIEF DESCRIPTION OF THE SEVERAL VIEWS OF THE DRAWING

FIG. 1 is a plan view of a representative calendar designed by this invention

FIG. 2 is a flow chart of one embodiment of the process of making and distributing the calendars of the present invention.

### DETAILED DESCRIPTION OF SOME EMBODIMENTS OF THE INVENTION

In this patent application the term “restricted constituency” means an organization restricted to suppliers and distributors in a single industry. “Accessible information” means information used by a consumer to identify and communicate with a seller, such as business name, address, telephone number, website address, and e-mail address. “Identifying symbols” means symbols such as numbers used by members of a restricted constituency to identify each other but which are not generally known by the general public or customers of members of the restricted constituency. “Promotional offers” means coupons or certificates which offer reduced prices or additional items to the end user making a purchase. Promotional offers may be offered by suppliers or by distributors. “Promotional specialty items” means useful items such as pens, letter openers, balloons, etc. which are customized with the customer's identification information, such as name, logo, address, telephone, fax, and e-mail numbers, and website addresses. The term “supplier” is used to designate a manufacturer or wholesaler who customizes the promotional specialty items. The term “distributor” means a person or organization who accepts orders from customers along with the customized identification material to be placed on the promotional specialty items, transmits the order to the supplier, and provides the customer with the customized promotional specialty items. The term “customer” means the person or organization who desires promotional specialty items customized with the customer's identification information, such as name, logo, address, telephone, fax, and e-mail numbers, and website addresses. Customer's, who often have retail or service organizations, typically distribute the customized promotional specialty items gratis or as nominal cost to the customer's patrons, termed “users” in this patent application.

Two examples of limited constituency organizations are the Advertising Specialty Institute (ASI) and the Promotional Products Association International (PPAI). ASI members are suppliers and distributors of promotional specialty items. Promotional specialty items are typically are custom imprinted with accessible information about the retailer. Promotional specialty items typically are distributed by a retailer to a customer on a free or nominal cost basis. Suppliers manufacture or obtain the promotional specialty items and imprint the items with the retailer's accessible information. The distributors deal with the retailers in obtaining orders for the items, providing the supplier with the accessible information for imprinting on the items, and distributing the items to the retailers.

Each member of a limited constituency is assigned a unique identifying symbol; in the case of ASI, a number. The symbol does not contain accessible information, but may be used by members of the limited constituency to obtain accessible information on the holder of the identifying symbol.

Members of the limited constituency such as ASI are free to buy and sell to anyone. In fact, one of the requirements for membership in ASI of a nonmember distributor is demonstration of a number of invoices showing purchases from ASI member suppliers. This demonstrates that the candidate member distributor is a bona fide active distributor in the promotional specialty product industry.

In promotional and advertising material authorized by or sponsored by a limited constituency, and typically supplied to a customer by a distributor, the suppliers are identified only by identifying symbol, in the case of ASI, the ASI number. The distributor is identified by accessible information. This insures that a customer will process his or her order through the distributor rather than dealing directly with the supplier for the promotional specialty items.

### EXAMPLE 1

Example 1 is one embodiment limited constituency calendar. In this example, the suppliers manufacture and personalize promotional specialty goods. Such goods, such as pens, pencils, envelope openers, hats, mouse pads, etc., are items which are personalized with a retailer's identification material, such as name, address, telephone number, website, e-mail address. The promotional goods are distributed to customers of the retailer free or at a nominal charge, and are considered part of the retailer's marketing program.

The distributor solicits the retailers through sales calls, catalogues, and calendars. Both the suppliers and the distributor are members of a limited constituency organization.

The calendar of this example has 12 primary advertisements featuring the products of 12 suppliers. Each primary advertisement has a seasonal theme based on the month of the year the advertisement is associated with. Each primary advertisement features products manufactured by the supplier which fit with the seasonal theme, and may include other products of the supplier. The primary advertisements also may include promotional offers, such as coupons which may be used to obtain the products of the supplier as at reduced price when an order is placed with the supplier. In an alternative configuration, several suppliers would share the primary advertisements associated with one month. The primary advertisements do not include accessible information which would allow the customer, who is the ultimate user of the calendar, to contact the supplier, but includes only identification symbols which allows the distributor to identify and contact the suppliers. The primary advertisements may include website information leading to an end user friendly website. Such a website contains additional product information which may include products not on the calendar described in this present patent application. The website does not include accessible information which would allow the customer to order directly from the supplier. There are instructions for a customer to contact his or her distributor to make an order. The website may include an e-mail address whereby the supplier will provide a customer with a list of distributors who are members of the restricted constituency along with accessible information which will enable the customer to contact the distributor and submit an order for promotional specialty items.

TABLE 1

| Month | Theme | Promotional Specialty Items |
|---|---|---|
| January | New Year | Champagne Glasses. |
| February | Valentine Day | Candy |
| March | Change of Seasons | Sports Items |
| April | Golf | Tees |
| May | Memorial Day | Flags |
| June | Summer Begins | Sunblock |
| July | 4th of July | Travel Items |
| August | Back to School | Pens |
| September | Back to Work | Desk items |
| October | Halloween | Safety items for children |
| November | Thanksgiving | Recognition Awards |
| December | Holidays | Food |

Each calendar of this example also will have an advertisement by a single distributor. The distributor's advertisement will include accessible information which will allow the user, to contact the distributor. The distributor's advertisement also may include promotional offers.

In this example, the distributor will provide his or her customers with calendars at no charge. The distributor takes orders from his or her customers; typically retailers or service providers who wish to obtain personalized items for distribution to users on a gratis or nominal charge basis. The distributor orders the personalized items from the supplier who customizes the items with the customer's information.

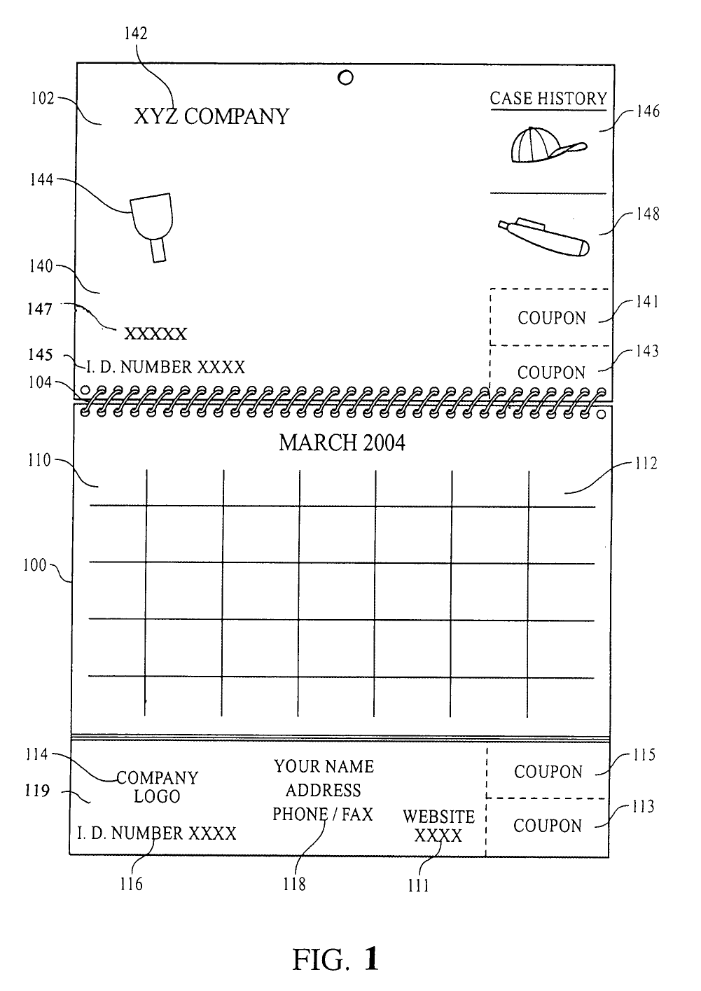

FIG. 1 is a plan view of a representative calendar designed by this invention. In this embodiment, the calendar 100 is in two primary parts, the primary advertisement 102 sheet which has a hole for hanging the calendar. The first month primary advertisement 140 is printed on the first sheet. A collection, typically 12-14 of date sheets 110 are bound by a spiral binding 104. The date sheets contain the information 112 normally found on a calendar sheet which covers one month, as well as information on special days, space for notations by the users, etc. The second month primary advertisement is printed on the back of the first month date sheet. The second (and subsequent) month primary advertisements typically will contain information concerning a different supplier from that of the first primary advertiser.

The primary advertisement features the supplier's name 142, a primary product advertisement 144, secondary product advertisements 146 and 148, and promotional offers 141 and 143. An identification symbol 145 is used to enable a customer to identify the supplier to a distributor when the customer wishes to place an order. A user-friendly website 147 may be included to allow a customer to obtain additional information on products. No accessible information which would allow the customer to place an order directly with the supplier is included on the primary advertisement.

The last page of the calendar is a hang sheet 114 which extends below the date sheets and is visible to the user throughout the year. The hang sheet features accessible data such as name, address, telephone, fax, e-mail numbers 118, distributor's company logo 119, website address 111, and promotional offers 113 and 115. In addition, the limited constituency identification symbol 116 is included.

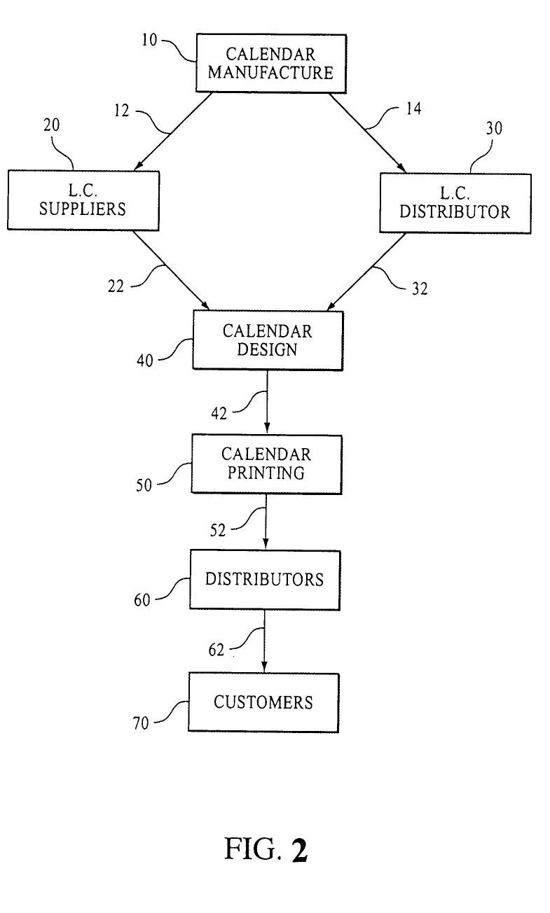

FIG. 2 is a flow chart of the process of making and distributing the calendars of the present invention.

The process begins when the calendar manufacturer 10 solicits advertisements 12 from several suppliers 20 all of whom are members of a limited constituency organization. The calendar manufacturer 10 also solicits an advertisement 14 from a single distributor 30 who also is a member of the limited constituency organization. The order of the solicitations in steps 12 and 14 is not important.

Advertisement and promotional offer information from the suppliers are communicated 22 by the supplier to the calendar manufactures for the process of calendar design 40. A typical supplier advertisement would be on a sheet facing a month's calendar and would include a number of advertisements from a supplier who is identified only by identification symbol. Alternatively, more than one supplier would share the advertisements for a month. Each supplier would be identified only by identification symbol.

The calendar designs are communicated 42 to the calendar printer where they are printed 50.

Printed calendars are conveyed 52 to the distributor 60 whose advertisement appears in the calendar.

Finally, the calendars are distributed 62 by the distributor to his or her customers 70 who use the calendars to obtain information on the supplier's products.

It will be apparent to those skilled in the art that the examples and embodiments described herein are by way of illustration and not of limitation, and that other examples may be used without departing from the spirit and scope of the present invention, as set forth in the appended claims.

1. The process of producing calendars in which both the suppliers who advertise in the calendars and the distributors of the calendars to retail customers are both members of a limited constituency, comprising the steps;
a. soliciting advertisements and suppliers' promotional offers from suppliers who are members of the limited constituency,
b. soliciting advertisements from a distributor, who is a member of the limited constituency,
c. combining the advertisements and suppliers' promotional offers into printed calendars,
d. printing the calendars, wherein the calendars comprise accessible information about the distributor and only identifying symbols about the suppliers, and
e. selling the printed calendars to the distributor who is a member of the limited constituency.

2. The process of producing calendars in which both the suppliers who advertise in the calendars and the distributors of the calendars to retail customers are both members of a limited constituency, comprising the steps;
a. soliciting advertisements from suppliers who are members of the limited constituency,
b. soliciting advertisements and promotional offers from a distributor who is a member of the limited constituency,
c. combining the advertisements and distributor's promotional offers into printed calendars,
d. printing the calendars, wherein the calendars comprise accessible information about the distributor and only identifying symbols about the suppliers, and
e. selling the printed calendars to the distributor who is a member of the limited constituency.

3. The process of claim 1 further comprising the step:
f. distributing the calendars by the distributor to the customers and prospective customers of the distributor.

4. The process of claim 2 further comprising the step:
f. distributing the calendars by the distributor to the customers and prospective customers of the distributor.

5. The process of claim 1 wherein the promotional offers are money off coupons.

6. The process of claim 2 wherein the promotional offers are money off coupons.
